(19) United States
(12) Patent Application Publication
(10) Pub. No.: US 2025/0108496 A1
(43) Pub. Date: Apr. 3, 2025

(54) Power tool with hammer mechanism

(71) Applicant: Hilti Aktiengesellschaft, Schaan (LI)

(72) Inventor: Rory BRITZ, Starnberg (DE)

(21) Appl. No.: 18/729,191

(22) PCT Filed: Feb. 13, 2023
(86) PCT No.: PCT/EP2023/053474

§ 371 Date: Jul. 16, 2024

(30) Foreign Application Priority Data
Feb. 24, 2022 (EP) 22158374.3

(51) Int. Cl. B25D 11/06; B25D 17/06

(52) U.S. Cl. CPC B25D 11/062; B25D 17/06; B25D 2217/0023

(57) ABSTRACT

A power tool with hammer mechanism including: a housing; a hollow spindle located in the housing; a hammering unit including a piston reciprocatingly mounted within the spindle; a swashplate drive unit for driving the piston reciprocatingly; the swashplate drive unit including a swashplate finger engaged with the rear end of the piston; the piston including a through opening mostly perpendicular to the longitudinal axis of the piston at its rear end, a free end of the swashplate finger is received directly in the through opening of the piston, at least a part of outer surface of the free end of the finger contacting at least part of inner surface of the through opening during reciprocation of the piston. Such a direct coupling between the swashplate finger and the drive piston minimizes numbers of the parts, reduces complexity of the assembly and the cost.

### TECHNICAL FIELD

The present invention relates to a hand-held power tool, and more particularly, the present invention relates to a power tool with a hammer mechanism.

### BACKGROUND

Hand-held power tools, in particular rotary hammers and chisel hammers, that include a hammer mechanism and a swashplate driving unit with a swashplate body and a piston are already known. In the hammers, a swashplate driving unit is generally used to convert a rotary drive from the motor to the reciprocating drive of the piston. In a known arrangement the rotary drive from the motor is transmitted to an intermediate shaft mounted within the hammer housing generally parallel to the axis of the spindle. A swashplate sleeve is rotatably mounted on the intermediate shaft. The swashplate sleeve is formed with a swashplate race which extends around the swashplate sleeve at an oblique angle to the axis of the intermediate shaft. Bearings are set to run between this inner race and an outer race of a swashplate ring. A swashplate finger extends outwardly from the swashplate ring to engage with the rearward end of the piston.

### SUMMARY OF THE INVENTION

It is well known that the swashplate finger reciprocatingly drives the piston via a trunnion arrangement, which generally includes a pair of spaced arms extending rearwardly of the main body of the piston and a cross bolt. Each arm is formed with a through hole and the cross bolt is received through said through holes. A central portion of the cross bolt, lying between the two arms is formed with a through hole, through which the end of the swashplate finger remote from the swashplate ring extends. Two washers (one on each side of the swashplate finger) are often combined with the cross bolt to form the connection between the swashplate finger and the piston. This setup is very difficult to assemble as the cross bolt needs to be rotationally and axially positioned. Also, the drive piston, swashplate and washer need to be in the right position. The high number of the parts increase the cost. As the cross bolt typically is made from steel it significantly increases the accelerated masses leading to higher vibration and increased wear.

It is an object of the present invention to provide a power tool with a hammer mechanism which is easy to assemble and has reduced wear and losses.

According to the present invention there is provided a power tool with a hammer mechanism comprising: a housing; a hollow spindle located in the housing; a hammering unit including a piston reciprocatingly mounted within the spindle; a swashplate drive unit for driving the piston reciprocatingly; said swashplate drive unit comprising a swashplate finger engaged with the rear end of the piston; said piston including a through opening mostly perpendicular to the longitudinal axis of the piston at its rear end, a free end of the swashplate finger is received directly in the through opening of the piston, at least a part of outer surface of the free end of the finger contacting at least part of inner surface of the through opening during reciprocation of the piston. Such a direct coupling between the swashplate finger and the drive piston minimizes numbers of the parts, reduces complexity of the assembly and the cost.

In one embodiment, said through opening defines an elongate slot having its length oriented in the direction of longitudinal axis of the piston, said length of the elongate slot being reduced from a top face and a bottom face of the piston respectively to its center axis. Hereby the through openings on the piston provides a matching counter shape by defining an elongate slot with various length along the longitudinal axis of the piston to the swing movement of the swashplate finger.

An advantageous embodiment is characterized in that said free end of swashplate finger is form as a cylinder shape, and the smallest length of the elongate slot is not smaller than the diameter of the free end. Such a cylindric swashplate finger is easy to manufacture and assemble and the elongate slot longer than the diameter of the finger allows the swashplate finger to sway within the through opening so as to drive the piston forwardly and rearwardly.

An advantageous embodiment is characterized in that said through opening comprises a front contacting surface at its front end of the elongate slot and an opposite rear contacting surface at its rear end of the elongate slot, and wherein said front contacting surface or said rear contacting surface at least partially contact the free end of the swashplate finger during reciprocation of the piston. Hereby the contacting between the swashplate finger and the piston is a “surface contacting”, so that the wear could be reduced, compared with the line contacting.

An advantageous embodiment is characterized in that the front contacting surface and rear contacting surface are both formed as an arc shape in vertical cross section along the longitudinal axis of the piston, two end of the arc shape being respectively at the top and bottom face of the piston and the vertex of the arc being at the central axis. As the swashplate finger is driven forwardly and rearwardly like the swing of the pendulum, the arc shape of the inner surface of the through opening will reduce the risk of being stuck of the swashplate finger.

An advantageous embodiment is characterized in that the front contacting surface includes a first inclined face which inclines from the top face to the central axis and a second inclined face which inclines from the bottom face to the central axis, and the rear contacting surface includes a third inclined face which inclines from the top face to the central axis and a fourth inclined face which inclines from the bottom face to the central axis.

An advantageous embodiment is characterized in that the angle of inclination of the first to the fourth inclined face are same, which are equal to half of the pendulum angle of the swashplate finger. The inclined contacting surface will coincide with the free end of swashplate finger respectively during the swing of finger, so that the driven force exerted onto the piston is more uniform and the wear between the piston and finger would be reduced.

An advantageous embodiment is characterized in that the front contacting surface and rear contacting surface has a semicircular shape along the length direction of the elongated slot for receiving said cylinder free end of the swashplate finger. The contacting surface of the through opening provide a matching contour to the cylindric swashplate finger thereby further reducing the wear between them.

In one other embodiment, said through opening defines an oval hole having its length oriented in the direction of longitudinal axis of the piston, said length of the oval hole being reduced from both top face and bottom face of the piston to its centre axis.

An advantageous embodiment is characterized in that said free end of swashplate finger is form as an olivary shape, and the smallest length of the oval hole is not smaller than the biggest diameter of the olivary shape of swashplate finger. Hereby an oval shape of matching contours of the swashplate finger and the through opening provides an alternative direct connection between swashplate finger and the piston to reduce the wear and losses.

An advantageous embodiment is characterized in that the inner surface of the oval hole is formed as a curved surface, corresponding to the olivary shape of the finger, so that the free end of swashplate finger partially contacting the inner surface of said oval hole in a surface contact relationship during reciprocation of swashplate finger. Hereby, the surface contacting relationship increases the load bearing capacity and wear-resisting.

In a further embodiment, a power tool with a hammering unit comprising: a housing; a hollow spindle is located in the housing; a hammering unit including a piston reciprocatingly mounted within the spindle; a swashplate drive unit for driving the piston reciprocatingly; said swashplate drive unit comprising a rotatably driven swashplate sleeve with a swashplate ring mounted on the swashplate sleeve via a bearing positioned at an angle oblique to the longitudinal axis of the sleeve and a swashplate finger extends outwardly of the swashplate ring for engaging the piston; said piston including a through opening perpendicular to the longitudinal axis of the piston at its rear end, characterized in that an extra part is added onto the swashplate finger, which is received in the through opening of the piston, at least a part of outer surface of extra part contacting at least a part of inner surface of the through opening. By adding an extra part on the free end of the swashplate finger, the driven load could be increased highly, and the power tool can be used for high loads of working.

An advantageous embodiment is characterized in that said through opening defines an elongate slot having its length oriented in the direction of longitudinal axis of the piston, said elongate slot comprises a front contacting surface at its front side and an opposite rear contacting surface at its rear side, which at least partially contact outer surface of the extra part.

An advantageous embodiment is characterized in that said extra part being configured to form as a rectangular shape; and the front contacting surface and rear contacting surface are formed as convex faces.

An advantageous embodiment is characterized in that wherein said extra part being configured to form as an involute shaped, and the front contacting surface and rear contacting surface being configured to form as nearly straight faces. An involute shape of the extra part on the finger is to create a linear movement from a rotational movement-like a gear wheel and a tooth rack. For an involute tooth rack with pressure angle 0°, the geometry would be a cylindrical hole, therefore the through hole is formed as nearly straight.

The invention directly couples the finger of the swashplate with the drive piston, thereby minimizing numbers of the parts, reducing complexity of the assembly and the cost. By wisely choosing the geometry of the drive piston and the finger of the swashplate and also choosing a proper material combination, the wear and losses can be minimized. If in case very high loads and high lifetime requirements the direct connection is overloaded, adding an extra part onto the free end of the swashplate finger, increases the load bearing capacity and wear-resisting.

### BRIEF DESCRIPTION OF THE DRAWINGS

Further features and advantages of the invention are described in greater detail hereinafter by means of an embodiment by way of example with reference to the drawings. In the Figures:

FIG. 1 shows a partial schematic view of a power tool with a hammering mechanism, in a side view, according to one embodiment of the present invention.

FIG. 2 shows of a partial schematic view of the connection of the swashplate finger and the piston according to the embodiment of FIG. 1

FIG. 3 shows of a simplified partial schematic view of the connection of the swashplate finger and the piston according to the embodiment shown as FIG. 1 and FIG. 2

FIG. 4 shows a simplified partial schematic view of the connection of the swashplate finger and the piston according to one other embodiment of the present invention.

FIG. 5 shows a simplified partial schematic view of the connection of the swashplate finger and the piston according to another embodiment of the present invention.

FIG. 6 shows a simplified partial schematic view of the connection of the swashplate finger with an extra part and the piston.

FIG. 7 shows a simplified partial schematic view of the connection of the swashplate finger with an extra part and the piston according to another yet embodiment of the present invention.

In the drawings, like reference numerals are used to indicate like parts throughout the various views.

### DETAILED DESCRIPTION

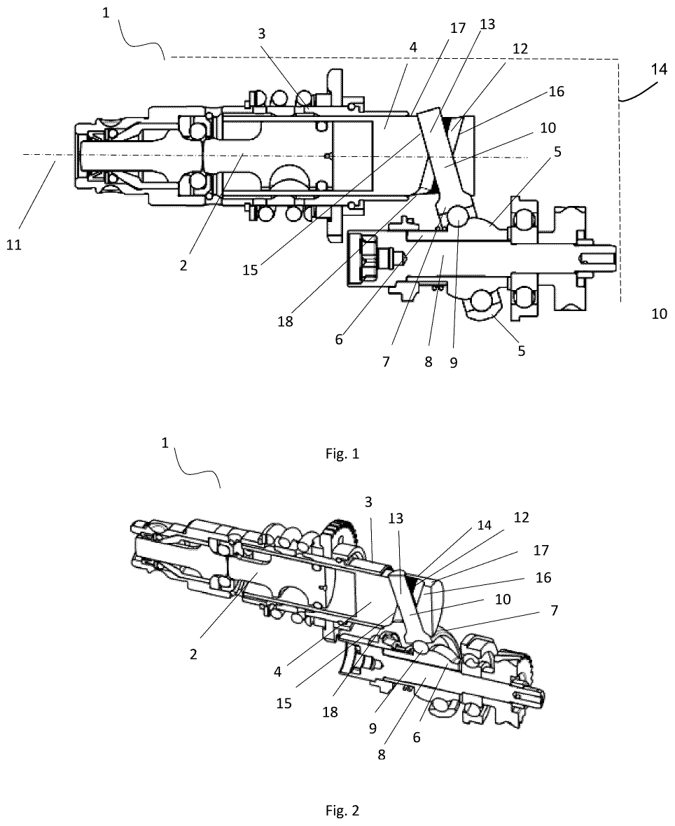

FIG. 1 shows a side view of a hand-held power tool 1 with a hammering unit 2 designed as a rotary hammer. The rotary hammer has a forward portion which is shown in FIGS. 1 to 7 and a rearward portion incorporating a motor and a rear handle, in the conventional way. The rotary hammer comprises a housing H, shown solely schematically; a hollow spindle 3 is located in the housing; the hammering unit 2 including a hollow cylindrical piston 4 reciprocatingly mounted within the spindle 3; a swashplate drive unit 5 for driving the piston 4 reciprocatingly. the swashplate drive unit 5 comprises a rotatably driven swashplate sleeve 6 with a swashplate ring 7 mounted on the swashplate sleeve 6 via a bearing 9 positioned at an angle oblique to the longitudinal axis of the sleeve 6.

As is best seen in FIGS. 1 and 2, the swashplate sleeve 6 is mounted on an intermediate shaft 8, so that it can rotate with respect to the intermediate shaft. The swashplate sleeve 6 carries an inner race for the ball bearings 9 of a swashplate ring 7. The ball bearings 9 are mounted between the inner race and an outer race formed in the swashplate ring 7. A swashplate finger 10 extends outwardly from the swashplate ring 7. Thus, as the swashplate sleeve 6 rotates the free end of the swashplate finger 10 remote from the swashplate ring 7 is caused to reciprocate, in order to reciprocatingly drive the piston 4. During hammering, the swashplate finger 10 is reciprocatingly driven forwardly and rearwardly by the swashplate drive unit 5, thereby the swashplate finger 10 reciprocatingly driving the piston 4 by engaging with the piston 4.

According to one embodiment of the present invention, the piston 4 has a hollow cylindrical shape with a center axis 11, extending along with the longitudinal axis and at the center of the cylindric piston. The rear end of the piston 4 is solid cylindrical shape and is a through opening 12 is located in the rear end of the piston 4. The through opening 12 runs through the rear end of the piston, substantially perpendicular | to the longitudinal axis, therefore, the top of the through opening is on its top face 17 of the circumferential surface of cylindrical piston 4 while the bottom of the through opening is on its bottom face 18 (closer to the swashplate ring 7) of the circumferential face of cylindrical piston 4. As it is known that although the current design is perpendicular, slight angles of the through openings would also be feasible.

The swashplate finger 10 includes a free end 13, which inserts into the through opening 12. Without any other part, such as trunnion arrangement including a cross bolt, the swashplate finger 10 contacts the side face of the hole directly, thus the assemble process will be much easier, and cost will decrease significantly due to the reduced numbers of the parts.

In an advantageous embodiment, the free end 13 of the swashplate finger 10 is formed as a cylindrical shape. As shown in FIGS. 1 to 3, the cross section of the free end of swashplate finger 10 is round. Alternatively, the free end 13 of the swashplate finger 10 is possible to be formed as a tapered shape or any other suitable shape. Generally, any shape that is round in the cross section is feasible.

Preferably, the through opening 12 defines an elongate slot 14 having its length oriented in the direction of longitudinal axis of the piston. Moreover, the length of the elongate slot 14 reduces from both the top face 17 and bottom face 18 of the piston respectively to its center axis 11. The smallest length of the elongate slot is not smaller than the diameter of the free end. Hereby, the free end 13 of the swashplate finger 10 could swing within the elongated slot 14.

The through opening 12 comprises a front contacting surface 15 at its front side and an opposite rear contacting surface 16 at its rear side. The front contacting surface 15 and the rear contacting surface 16 at least partially contact the free end of the swashplate finger.

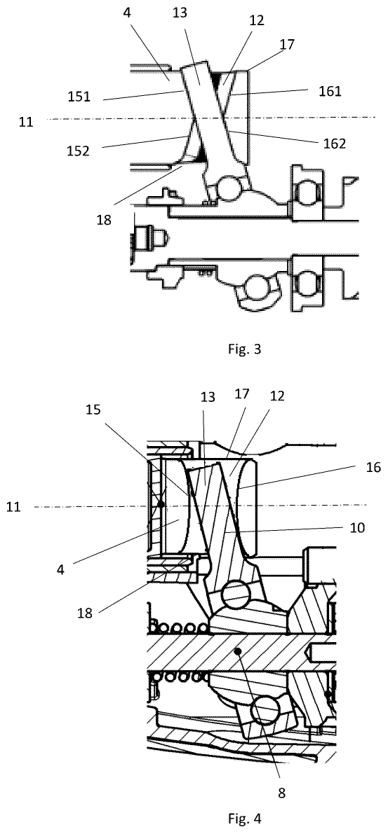

As best shown in FIG. 3, the front contacting surface 15 includes a first inclined face 151 which inclines from the top face 17 to the central axis and a second inclined face 152 which inclines from the bottom face 18 to the central axis, and the rear contacting surface includes a third inclined face 161 which inclines from the top face 17 to the central axis and a fourth inclined face 162 which inclines from the bottom face 18 to the central axis. Preferably, the angle of inclination of the first to the fourth inclined face are same, which are equal to half of the pendulum angle of the swashplate finger 10. When the swashplate finger 10 is at its most forward position, the swashplate finger will contact the first inclined face 151 and the fourth inclined face 162 simultaneously. When the swashplate finger 10 is at its most rearward position, the swashplate finger 10 will contact the second inclined face 152 and the third inclined face 161 simultaneously. This is helpful to reduce the wear and increase the working stability of the swashplate drive unit.

According to an advantageous embodiment, the front contacting surface 15 and rear contacting surface 16 are both formed as semicircular shape along the length direction of the elongated slot 14 for receiving said cylindrical or conical shape of free end of the swashplate finger. The contacting surfaces 15 and 16 of the through opening provide matching contour to the cylindric swashplate finger. Thus, the swashplate finger 10 contact the front contacting surface 15 and/or rear surface 16 in large area, so as to drive the piston to move reciprocatingly more smoothly and reduce the wear as well.

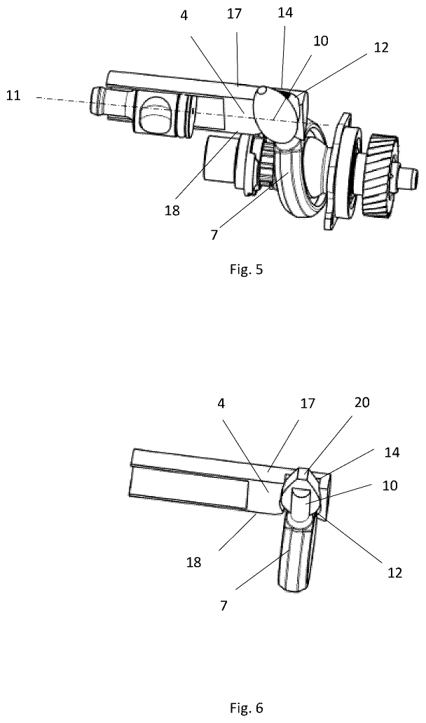

Alternatively, as shown in FIG. 4, the front contacting surface 15 and rear contacting surface 16 are both formed as an arc shape in vertical cross section along the longitudinal axis of the piston, two end of the arc shape being respectively at the top and bottom face of the piston and the vertex of the arc being at the central axis 11. This provides that the contact principle is changed from surface contact to line contact, thereby reduce the wear of swashplate finger.

FIG. 5 shows one other embodiment according to the present invention. Different to the embodiments shown in FIGS. 1 to 3, the through opening 10 is formed as an oval shape of through hole having its length oriented in the direction of longitudinal axis of the piston, said length of the oval hole being reduced from both top face and bottom face of the piston to its center axis 11. Then, the elongated slot 14 would be an oval shape at the top face and bottom face of the piston, rather than a rectangular shape. Meanwhile, the swashplate finger 10 is form as an olivary shape, and the smallest length of the oval hole is not smaller than the biggest diameter of the olivary shape of swashplate finger. Hereby, the front and rear contacting surface have a matching counter shape with the swashplate finger.

Preferably, the inner surface of the oval hole is formed as a curved surface, corresponding to the olivary shape of the finger, so that the free end of swashplate finger partially contacting the inner surface of said oval hole in a surface contact relationship during reciprocation of swashplate finger.

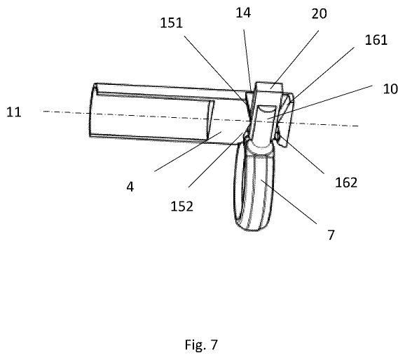

FIGS. 6 and 7 show another embodiment according to the present invention, in case of very high loads and high lifetime requirements, the direct connection between the swashplate finger and the piston is overloaded, there is a need to change the shape and geometry of the swashplate finger and the hole, increase the load bearing capacity. Compared with the power tool with hammering unit shown in the FIGS. 1-4, the difference here is an extra part 20 added onto f the swashplate finger 10, so that at least a part of outer surface of extra part 20 contact at least a part of inner surface of the through opening 12.

Refer to FIG. 6, the extra part 20 here is formed an involute shape while the swashplate finger is a cylinder pin inserting within the extra part. Correspondingly, the through hole 12 is nearly straight. The extra part 20 with an involute shape will increase the load bearing capacity. Basically, the task to solve is to create a linear movement from a rotational movement-like a gear wheel and a tooth rack. So, any geometry that fulfills the basic laws for a toothed can be used.

Now, referring to FIG. 7, in this further another embodiment, the through opening 12 is similar to the through opening shown in the embodiment of FIGS. 1 and 2. But the extra part 20 added onto the swashplate finger is rectangular shape. Such a rectangular shape of extra part is easy to assemble.

For the material, most probably pressure resistant materials, for example, steel, would be preferred. Nevertheless, due to the low E-module of plastic materials the contact surface can increase (the parts flatten under pressure) und also such materials might become usable.

While only selected embodiments have been chosen to illustrate the present invention, it will be apparent to those skilled in the art from this disclosure that various changes and modifications can be made herein without departing from the scope of the invention as defined in the appended claims. Thus, the foregoing descriptions of the embodiments according to the present invention are provided for illustration only, and not for the purpose of limiting the invention as defined by the appended claims and their equivalents.

1-15. (canceled)

16. A power tool with a hammer mechanism, the power tool comprising:
a housing;
a hollow spindle located in the housing;
a hammering unit including a piston reciprocatingly mounted within the spindle;
a swashplate drive unit for driving the piston reciprocatingly, the swashplate drive unit including a swashplate finger engaged with the piston;
the piston including a through opening substantially perpendicular to a longitudinal axis of the piston at a rear end, a free end of the swashplate finger being received directly in the through opening of the piston, at least a part of outer surface of the free end of the swashplate finger contacting at least part of an inner surface of the through opening.

17. The power tool as recited in claim 16 wherein the through opening defines an elongate slot having a length oriented in the direction of the longitudinal axis of the piston, a length of the elongate slot being reduced from a top face and a bottom face of the piston with respect to a central axis.

18. The power tool as recited in claim 17 wherein the free end of the swashplate finger is a cylinder, and a smallest length of the elongate slot is not smaller than the diameter of the free end.

19. The power tool as recited in claim 18 wherein the through opening comprises a front contacting surface at a front end of the elongate slot and an opposite rear contacting surface at a rear end of the elongate slot, and wherein the front contacting surface or the rear contacting surface at least partially contacts the free end of the swashplate finger during reciprocation of the piston.

20. The power tool as recited in claim 19 wherein the front contacting surface and rear contacting surface are both formed as an arc shape in vertical cross section along the longitudinal axis of the piston, two ends of the arc shape being respectively at the top face and bottom face of the piston and the vertex of the arc being at the central axis of the piston.

21. The power tool as recited in claim 19 wherein the front contacting surface includes a first inclined face inclining from the top face to the central axis of the piston and a second inclined face inclining from the bottom face to the central axis of the piston, and the rear contacting surface includes a third inclined face inclining from the top face to the central axis of the piston and a fourth inclined face inclining from the bottom face to the central axis of the piston.

22. The power tool as recited in claim 21 wherein the angle of inclination of the first to the fourth inclined face are the same, and equal to half of the pendulum angle of the swashplate finger.

23. The power tool as recited in claim 19 wherein the front contacting surface and rear contacting surface has a semi-circular shape along the length direction of the elongated slot for receiving said free end of the swashplate finger.

24. The power tool as recited in claim 17 wherein the through opening defines an oval hole having its length oriented in the direction of longitudinal axis of the piston, the length of the oval hole being reduced from top face and bottom face of the piston respectively to the central of the piston.

25. The power tool as recited in claim 24 wherein the free end of swashplate finger has an olivary shape, and a smallest length of the oval hole is not smaller than the biggest diameter of the olivary shape of swashplate finger.

26. The power tool as recited in claim 24 wherein an inner surface of the oval hole is formed as a curved surface, corresponding to an olivary shape of the swashplate finger, so that the free end of swashplate finger partially contacts the inner surface of the oval hole in a surface contact relationship during reciprocation of the piston.

27. A power tool with a hammer mechanism, the power tool comprising:
a housing;
a hollow spindle located in the housing;
a hammering unit including a piston reciprocatingly mounted within the spindle;
a swashplate drive unit for driving the piston reciprocatingly, the swashplate drive unit including a swashplate finger engaged with the piston, the piston including a through opening mostly perpendicular to a longitudinal axis of the piston at a rear end, an extra part being added onto the swashplate finger, the swash plate finger received in the through opening of the piston, at least a part of an outer surface of extra part contacting at least a part of inner surface of the through opening.

28. The power tool as recited in claim 27 wherein said through opening defines an elongate slot having a length oriented in the direction of longitudinal axis of the piston and the through opening includes a front contacting surface at a front side of the elongate slot and an opposite rear contacting surface at a rear side of the elongate slot, and wherein the front contacting surface or the rear contacting surface at least partially contact the outer surface of the extra part during the reciprocation of the piston.

29. The power tool as recited in claim 28 wherein the extra part has a rectangular shape; and wherein the front contacting surface and rear contacting surface define convex faces.

30. The power tool as recited in claim 28 wherein said extra part is involute shaped, and wherein both the front contacting surface and rear contacting surface define straight faces.
